(19) United States
(12) Patent Application Publication
(10) Pub. No.: US 2009/0058785 A1
(43) Pub. Date: Mar. 5, 2009

(54) LIQUID CRYSTAL DISPLAY AND DRIVING METHOD THEREOF

(76) Inventors: Jung-Hwan Kim, Suwon-si (KR); Mu-Kyung Jeon, Suwon-si (KR); Hideo Yoshimura, Suwon-si (KR); Tae-Hyeog Jung, Suwon-si (KR)

Correspondence Address: CHRISTIE, PARKER & HALE, LLP, PO BOX 7068, PASADENA, CA, 91109-7068, US

(21) Appl. No.: 12/138,259

(22) Filed: Jun. 12, 2008

(30) Foreign Application Priority Data
Aug. 29, 2007 (KR) 10-2007-0087044

(51) Int. Cl. G09G 3/36

(52) U.S. Cl. 345/96

(57) ABSTRACT

A liquid crystal display including: a first common electrode line and a second common electrode line located near an edge of a panel and at least partly surrounding a plurality of pixels on the panel; a first common line positioned at an i^{th} horizontal row of the pixels and coupled to the first common electrode line; and a second common line positioned at an i+1^{th} horizontal row of the pixels and coupled to the second common electrode line; wherein each of the pixels includes a common electrode coupled to the first common line or the second common line.

### CROSS-REFERENCE TO RELATED APPLICATIONS

This application claims priority to and the benefit of Korean Patent Application No. 10-2007-0087044, filed on Aug. 29, 2007, in the Korean Intellectual Property Office, the entire content of which is incorporated herein by reference.

### BACKGROUND

1. Field of the Invention

The present invention relates to a liquid crystal display and a driving method thereof, and, more particularly, to a liquid crystal display and a driving method thereof for lowering power consumption.

2. Discussion of Related Art

Liquid crystal displays display images by controlling light transmittance of liquid crystals using electric fields. Such liquid crystal displays are classified as a vertical electric field type or a horizontal electric field type, according to the direction of the electric field driving the liquid crystals.

In the vertical electric field type liquid crystal display, a common electrode formed on an upper substrate and a pixel electrode formed on a lower substrate are opposite to each other to drive liquid crystals (for example, Twisted Nematise (TN) mode liquid crystals) using of a vertical electric field formed therebetween. Such a vertical electric field type liquid crystal display has an advantage of a large aperture ratio and a disadvantage of a narrow viewing angle.

In the horizontal electric field type liquid crystal display, liquid crystals (for example, In Plane Switch (IPS) mode liquid crystals) are driven using of a horizontal electric field between a pixel electrode and a common electrode parallel with each other on a lower substrate. Such a horizontal electric field type liquid crystal display has an advantage of a wide viewing angle.

Liquid crystal displays may be driven in an inversion method so that flicker is reduced. For example, the liquid crystal display is driven using of a frame inversion method, a line inversion method, a column inversion method, a dot inversion method, etc.

In the horizontal electric field type liquid crystal display, a common electrode is formed in an electrode line shape so that power consumption becomes high during inversion driving. When the horizontal electric field type liquid crystal display is driven in a line inversion method, the voltage supplied to the common electrode is changed per one horizontal period (1H) so that power consumption is high. Therefore, it is desireable to provide a horizontal electric field type liquid crystal display with reduced power consumption.

### SUMMARY OF THE INVENTION

An aspect according to an exemplary embodiment of the present invention is to provide a liquid crystal display and a driving method thereof with reduced power consumption by dividing common electrodes for reducing or minimizing resistance.

An embodiment of the present invention provides a liquid crystal display including: a first common electrode line and a second common electrode line located near an edge of a panel and at least partly surrounding a plurality of pixels on the panel; a first common line positioned at an i^{th} horizontal row of the pixels and coupled to the first common electrode line; and a second common line positioned at an i+1^{th} horizontal row of the pixels and coupled to the second common electrode line; wherein each of the pixels includes a common electrode coupled to the first common line or the second common line.

The liquid crystal display may further include a driving circuit for supplying a first common voltage to the first common electrode line and a second common voltage having an opposite polarity to the first common voltage to the second common electrode line.

The driving circuit may supply the first and second common voltages, and the common voltages may be inversed in polarity between two sequentially adjacent frames.

The liquid crystal display may further include: a plurality of gate lines respectively at the i^{th} horizontal row of the pixels and the i+1^{th} horizontal row of the pixels and coupled to the pixels, and a plurality of data line extending in a direction crossing the gate lines and coupled to the pixels.

Each of the pixels may include a thin film transistor including a gate electrode coupled to a corresponding one of the gate lines, a source electrode coupled to a corresponding one of the date lines, and a drain electrode coupled to a pixel electrode that is parallel to the common electrode.

The first common electrode line and the second common electrode line may include a source/drain metal.

The common electrode may include a pixel electrode metal located in a different layer from the source/drain metal.

Both ends of the first common line may be coupled to respective sides of the first common electrode line utilizing first contact holes, and both ends of the second common line may be coupled to respective sides of the second common electrode line utilizing second contact holes.

Another embodiment of the present invention provides a driving method for a liquid crystal display including: applying a first common voltage of positive polarity to a first common electrode line located near an edge of a panel and at least partly surrounding a plurality of pixels on the panel driving a j^{th} frame period and transferring the first common voltage to a first common line positioned at an i^{th} horizontal row of pixels; and applying a second common voltage of negative polarity to a second common electrode line located near the edge of the panel and at least partly surrounding the plurality of pixels on the panel driving the j^{th} frame period and transferring the second common voltage to a second common electrode line positioned at an i+1^{th} horizontal row of pixels, wherein the polarities of the first and second common voltages supplied to the first common electrode line and the second common electrode line are inversed in two sequentially adjacent frames.

Another embodiment of the present invention provides a liquid crystal panel including: a first common electrode line and a second common electrode line located near a periphery of a liquid crystal panel and at least partly surrounding a plurality of pixels on the liquid crystal panel; a first common line positioned at an i^{th} horizontal row of pixels and coupled to the first common electrode line; a second common line positioned at an i+1^{th} horizontal row of pixels and coupled to the second common electrode line, wherein each of the pixels includes a common electrode coupled to the first common line or the second common line; a driving circuit for supplying a first common voltage to the first common electrode line and a second common voltage having an opposite polarity to the first common voltage to the second common electrode line, wherein the common voltages are inversed in polarity between two sequentially adjacent frames; a plurality of gate lines respectively at the i^{th} horizontal row of pixels and the i+1^{th} horizontal row of pixels and coupled to the pixels; and a plurality of data line extending in a direction crossing the gate lines and coupled to the pixels.

Each of the pixels may include a thin film transistor including a gate electrode coupled to a corresponding one of the gate lines, a source electrode coupled to a corresponding one of the date lines, and a drain electrode coupled to a pixel electrode that is parallel to the common electrode.

Ends of the first common line may be coupled to respective portions of the first common electrode line utilizing first contact holes, and ends of the second common line may be coupled to respective portions of the second common electrode line utilizing second contact holes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view showing a lower substrate of a liquid crystal display according to an embodiment of the present invention;

FIG. 2 is a cross-sectional view showing a lower substrate taken along lines “II-II” of FIG. 1;

FIG. 3 is a schematic plan view showing an electrode line according to an embodiment of the present invention;

FIG. 4 is a cross-sectional view showing one example of a coupling process of the common line and the common electrode line of FIG. 3;

FIG. 5 is a schematic view showing a common voltage supplied to the common electrode lines of FIG. 3; and

FIG. 6 is a schematic view showing a panel driven in an line inversion method using of the common voltage of FIG. 5.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

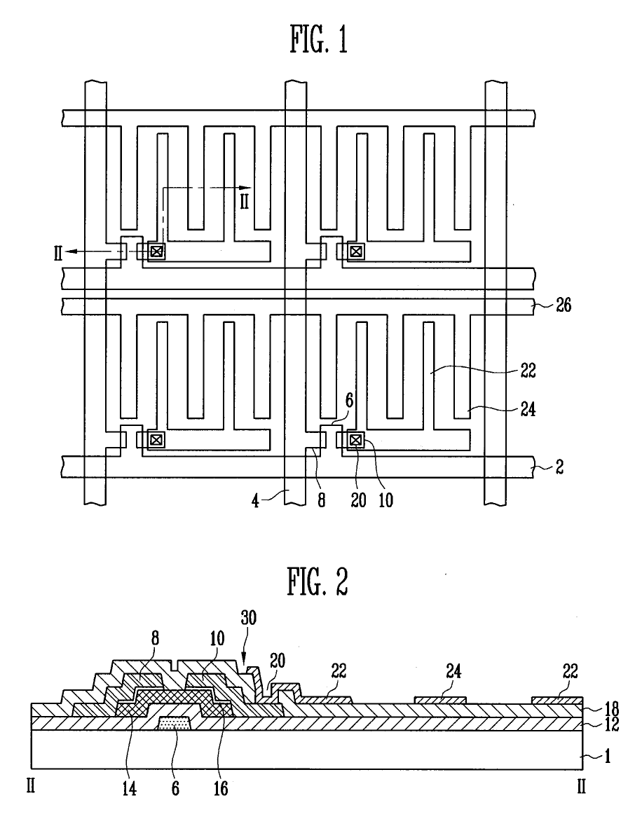

FIG. 1 is a plan view showing a lower substrate of a liquid crystal display according to an embodiment of the present invention, and FIG. 2 is a cross-sectional view showing a lower substrate taken along the lines “II-II” of FIG. 1.

Referring to FIGS. 1 and 2, the liquid crystal display includes: a gate line 2 and a data line 4 that cross each other on a lower substrate 1; a thin film transistor 30 located at each location where the gate line 2 and the data line 4 cross; a pixel electrode 22 and a common electrode 24 that make a horizontal electric field on a pixel region where the gate line 2 and the data line 4 cross; and a common line 26 coupled to the common electrode 24.

The gate line 2 supplies a scan signal to a gate electrode 6 of the thin film transistor 30. The data line 4 supplies a data signal to the pixel electrode 22 through a drain electrode 10 of the thin film transistor 30. The gate line 2 and the data line 4 cross to define a pixel region. The common line 26 is formed to be parallel to the gate line 2, having the pixel region therebetween, and supplies a common voltage for driving liquid crystals to the common electrode 24. The common line 26 is supplied with the common voltage whose voltage is changed in a frame unit from a first common electrode line and a second common electrode line. The detailed explanation thereof will be provided later.

The thin film transistor 30 charges and maintains the data signal of the data line 4 in the pixel electrode 22 in response to the scan signal of the gate line 2. TTo achieve this, the thin film transistor 30 includes the gate electrode 6 coupled to the gate line 2, a source electrode 8 coupled to the data line 4, and the drain electrode 10 coupled to the pixel electrode 22. Also, the thin film transistor 30 further includes: an active layer 14 forming a channel between the source electrode 8 and the drain electrode 10, overlapping with the gate electrode 6 having a gate insulating layer 12 therebetween; and an ohmic contact layer 16 for making the active layer 14 to have ohmic-contact with the source electrode 8 and the drain electrode 10.

The pixel electrode 22 is formed, on the pixel region, to be coupled to the drain electrode 10 of the thin film transistor 30 through a contact hole 20 that penetrates through a protection layer 18.

The common electrode 24 is coupled to the common line 26 in the pixel region. The common electrode 24 is formed to be parallel to the pixel electrode 22 in the pixel region. Accordingly, a horizontal electric field is formed between the pixel electrode 22 supplied with the data signal through the thin film transistor 30 and the common electrode 24 supplied with the common voltage through the common line 26. The liquid crystal molecules arranged in a horizontal direction between a lower substrate 1 and an upper substrate rotate utilizing dielectric anisotropy. The light transmittance of the pixel region is changed according to rotation degree of the liquid crystal molecules, thereby displaying images.

The structure of the lower substrate 1, as shown in FIG. 2, shows one example of a horizontal electric field type liquid crystal display, but the present invention is not limited thereto. In fact, the present invention can be applied to currently well-known various types of horizontal electric field type liquid crystal displays.

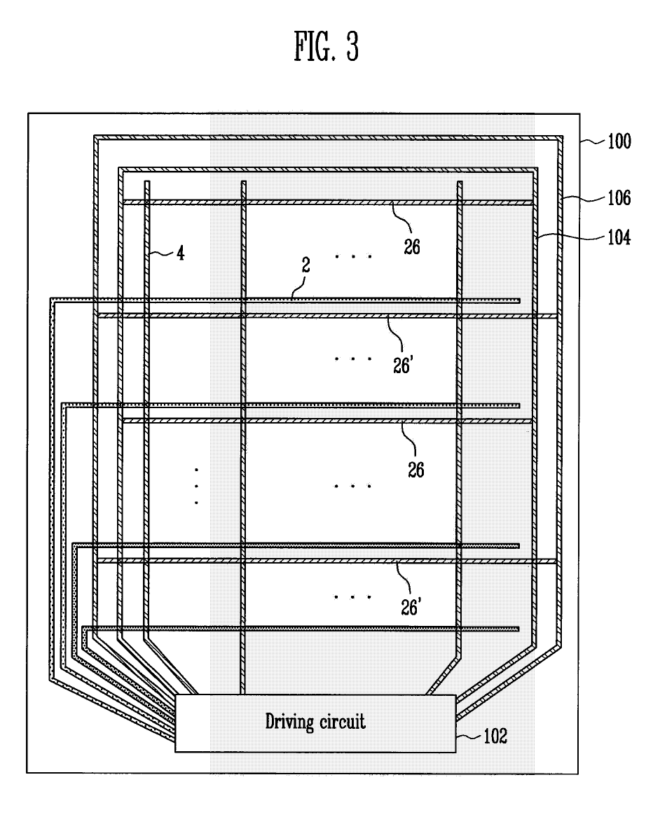

FIG. 3 is a schematic plan view showing an electrode line structure according to an embodiment of the present invention. FIG. 3 shows that a data line 4, a gate line 2, and a common line 26 are coupled to one driving circuit 102, however, the present invention is not limited thereto. When a liquid crystal display is utilized in a small-sized display such as a cellular phone, the data line 4, the gate line 2, and the common line 26 may be coupled to one driving circuit 102, as shown in FIG. 3. However, when the liquid crystal display is utilized in a large-sized display, such as television, etc., the data line 4, the gate line 2, and the common line 26 may be coupled to multiple different drivers.

Referring to FIGS. 2 and 3, when a gate electrode 6 is formed, the gate lines 2 are formed of gate metal concurrently with the gate electrode 6. Such gate lines 2 are sequentially supplied with scan signals from the driving circuit 102 to select pixels in a horizontal line (or horizontal row of pixels).

When a source electrode 8 and a drain electrode 10 are formed, the data lines 4 are formed of source/drain metal concurrently with the source electrode 8 and the drain electrode 10. The data lines 4 are supplied with the data signals from the driving circuit 102 in synchronization with the scan signals. Then, the data signals are supplied to the selected pixels using of the scan signals.

A first common electrode line 104 and a second common electrode line 106 are formed of the source/drain metal concurrently with the source electrode 8 and the drain electrode 10. The first common electrode line 104 and the second common electrode line 106 are formed to surround the pixels at or near an edge (or periphery) of a panel 100 from the both sides of the driving circuit 102. As can be seen in FIG. 3, in one exemplary embodiment, the display region having pixels is surrounded by each of the first and second common electrodes at the top, left, and right edges of the panel 100.

The common line 26 (first common line) positioned at an i^{th} (i is an odd number or an even number) horizontal line (or horizontal row of pixels) is electrically coupled to the first common electrode line 104. The common line 26 positioned at the i^{th} horizontal line (or horizontal row of pixels) is electrically coupled to both sides of the first common electrode line 104. As described above, the both sides of the first common electrode line 104 formed to surround the edge of the panel 100 are coupled to the common line 26 positioned at the i^{th} horizontal line (or horizontal row of pixels), making it possible to reduce or minimize the resistance of the common line 26.

The common line 26′ (second common line) positioned at an i+1^{th} horizontal line (or horizontal row of pixels) is electrically coupled to the second common electrode line 106. In fact, the common line 26′ positioned at the i+1^{th} horizontal line (or horizontal row of pixels) is electrically coupled to both sides of the second common electrode line 106. As described above, both sides of the second common electrode line 106 formed to surround the edge of the panel 100 are coupled to the common line 26′ positioned at the i+1^{th} horizontal line (or horizontal row of pixels), making it possible to minimize the resistance of the common line 26′.

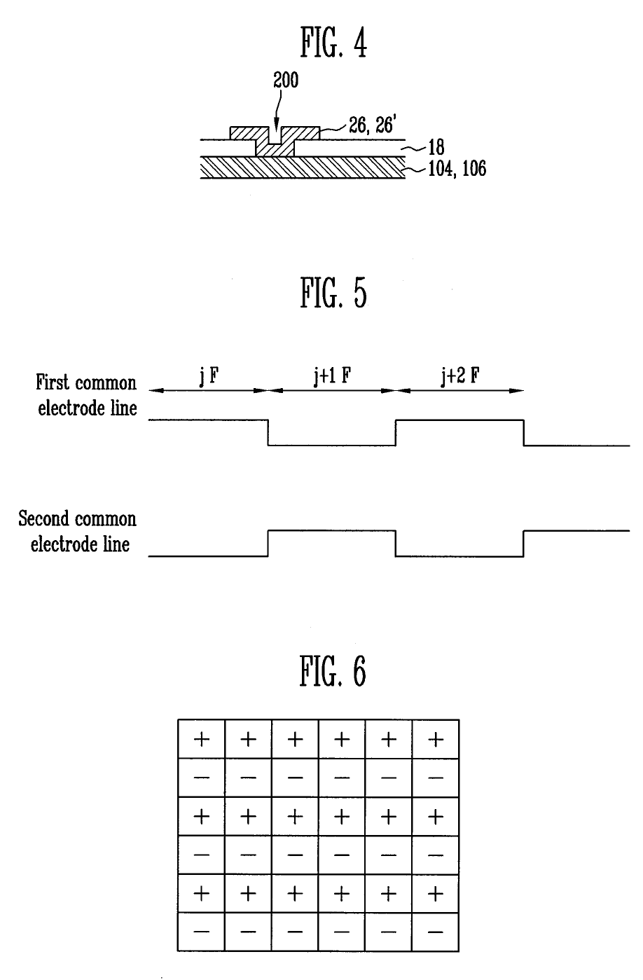

The first common electrode line 104 and the second common electrode line 106 are formed of a source/drain metal, and the common lines 26, 26′ are formed of a pixel electrode metal forming a pixel electrode 22. Therefore, as shown in FIG. 4, the common lines 26, 26′ are electrically coupled to the first common electrode line 104 and the second common electrode line 106, respectively, utilizing respective contact holes 200 positioned on both ends of the first common electrode line 104 and the second common electrode line 106.

FIG. 5 is a schematic view showing a common voltage supplied to first and second common electrode lines.

Referring to FIG. 5, the polarity of the common voltage supplied to the first and second common electrode lines is supplied such that its polarity is inversed in a frame unit, and the voltages of the first and second common electrodes have different polarities. For example, the first common electrode line can be supplied with positive polarity voltage for a j^{th} (j a is a natural number) frame period and can be supplied with negative polarity voltage for a j+1^{th} frame period. Concurrently, the second common electrode line is supplied with negative polarity voltage for the j^{th} frame period and is supplied with positive polarity voltage for the j+1^{th} frame period.

In other words, in the described embodiment of the present invention the voltage supplied to the first and second common electrode lines is inversed in a frame inversion method. Here, the first common electrode line is coupled to a common line 26 positioned at an i^{th} horizontal line (or horizontal row of pixels), and the second common electrode line is coupled to a common line 26′ positioned at an i+1^{th} horizontal line (or horizontal row of pixels) so that the polarity is inversed between two sequential horizontal lines (or horizontal rows of pixels).

In other words, when the common voltages that are inversed in sequentially adjacent frames are supplied to the first and second common electrode lines, the voltage is applied to a panel in a shape where its polarity is inversed between sequentially adjacent horizontal lines (or horizontal rows of pixels), i.e., a line inversion method, as shown in FIG. 6. That is to say, the described embodiment of the present invention can drive a liquid crystal display in a line inversion method, while supplying the common voltage in a frame inversion method. Therefore, the present invention can reduce or minimize power consumption.

In an exemplary embodiment of the present invention, a horizontal electric field type liquid crystal is injected between a lower substrate 1 and an upper substrate. Here, the common electrode is arranged in a line shape. For example, an In Plane Switch (IPS) mode liquid crystal or a Fringe Field Switching (FFS) mode liquid crystal may be injected between the lower substrate 1 and the upper substrate.

As described above, with the liquid crystal display and the driving method thereof according to an embodiment of the present invention, the first common electrode line and the second common electrode line surround the panel at (or near) the edge (or periphery) of the panel and are coupled to the common line, making it possible to reduce or minimize resistance. Also, with described embodiment of the present invention, the common line positioned at the i^{th} horizontal line (or horizontal row of pixels) is coupled to the first common electrode line and the common line positioned at the i+1^{th} horizontal line (or horizontal row of pixels) is coupled to the second common electrode line. Therefore, the voltages having polarity opposite to each other are supplied to the first common electrode line and the second common electrode line and are inversed between sequentially adjacent frames, making it possible to drive the liquid crystal display in a line inversion method. Therefore, power consumption may also be lowered.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid crystal display comprising:
a first common electrode line and a second common electrode line located near an edge of a panel and at least partly surrounding a plurality of pixels on the panel;
a first common line positioned at an i^{th} horizontal row of the pixels and coupled to the first common electrode line; and
a second common line positioned at an i+1^{th} horizontal row of the pixels and coupled to the second common electrode line; wherein
each of the pixels comprises a common electrode coupled to the first common line or the second common line.

2. The liquid crystal display as claimed in claim 1, further comprising a driving circuit for supplying a first common voltage to the first common electrode line and a second common voltage having an opposite polarity to the first common voltage to the second common electrode line.

3. The liquid crystal display as claimed in claim 2, wherein the driving circuit supplies the first and second common voltages, and wherein the common voltages are inversed in polarity between two sequentially adjacent frames.

4. The liquid crystal display as claimed in claim 1, further comprising:
a plurality of gate lines respectively at the i^{th} horizontal row of the pixels and the i+1^{th} horizontal row of the pixels and coupled to the pixels, and
a plurality of data line extending in a direction crossing the gate lines and coupled to the pixels.

5. The liquid crystal display as claimed in claim 4, wherein each of the pixels comprises a thin film transistor comprising a gate electrode coupled to a corresponding one of the gate lines, a source electrode coupled to a corresponding one of the date lines, and a drain electrode coupled to a pixel electrode that is parallel to the common electrode.

6. The liquid crystal display as claimed in claim 5, wherein the first common electrode line and the second common electrode line comprise a source/drain metal.

7. The liquid crystal display as claimed in claim 6, wherein the common electrode comprises a pixel electrode metal located in a different layer from the source/drain metal.

8. The liquid crystal display as claimed in claim 1, wherein both ends of the first common line are coupled to respective sides of the first common electrode line utilizing first contact holes, and both ends of the second common line are coupled to respective sides of the second common electrode line utilizing second contact holes.

9. A driving method for a liquid crystal display comprising:
applying a first common voltage of positive polarity to a first common electrode line located near an edge of a panel and at least partly surrounding a plurality of pixels on the panel driving a j^{th} frame period and transferring the first common voltage to a first common line positioned at an i^{th} horizontal row of pixels; and
applying a second common voltage of negative polarity to a second common electrode line located near the edge of the panel and at least partly surrounding the plurality of pixels on the panel driving the j^{th} frame period and transferring the second common voltage to a second common electrode line positioned at an i+1^{th} horizontal row of pixels,
wherein the polarities of the first and second common voltages supplied to the first common electrode line and the second common electrode line are inversed in two sequentially adjacent frames.

10. A liquid crystal panel comprising:
a first common electrode line and a second common electrode line located near a periphery of a liquid crystal panel and at least partly surrounding a plurality of pixels on the liquid crystal panel;
a first common line positioned at an i^{th} horizontal row of pixels and coupled to the first common electrode line;
a second common line positioned at an i+1^{th} horizontal row of pixels and coupled to the second common electrode line, wherein each of the pixels comprises a common electrode coupled to the first common line or the second common line;
a driving circuit for supplying a first common voltage to the first common electrode line and a second common voltage having an opposite polarity to the first common voltage to the second common electrode line, wherein the common voltages are inversed in polarity between two sequentially adjacent frames;
a plurality of gate lines respectively at the i^{th} horizontal row of pixels and the i+1^{th} horizontal row of pixels and coupled to the pixels; and
a plurality of data line extending in a direction crossing the gate lines and coupled to the pixels.

11. The liquid crystal panel as claimed in claim 10, wherein each of the pixels comprises a thin film transistor comprising a gate electrode coupled to a corresponding one of the gate lines, a source electrode coupled to a corresponding one of the date lines, and a drain electrode coupled to a pixel electrode that is parallel to the common electrode.

12. The liquid crystal panel as claimed in claim 10, wherein ends of the first common line are coupled to respective portions of the first common electrode line utilizing first contact holes, and ends of the second common line are coupled to respective portions of the second common electrode line at both ends of the second common line utilizing second contact holes.
